(19) United States
(12) Patent Application Publication
(10) Pub. No.: US 2012/0109860 A1
(43) Pub. Date: May 3, 2012

(54) Enhanced Training Data for Learning-To-Rank

(75) Inventors: Jingfang Xu, Beijing (CN); Hang Li, Beijing (CN); Gu Xu, Beijing (CN)

(73) Assignee: Microsoft Corporation, Redmond, WA (US)

(21) Appl. No.: 12/939,008

(22) Filed: Nov. 3, 2010

(51) Int. Cl. G06F 15/18

(52) U.S. Cl. 706/12

(57) ABSTRACT

Training data is used by learning-to-rank algorithms for formulating ranking algorithms. The training data can be initially provided by human judges, and then modeled in light of user click-through data to detect probable ranking errors. The probable ranking errors are provided to the original human judges, who can refine the training data in light of this information.

### BACKGROUND

Machine-learned algorithms can be used in various different information retrieval activities, such as document searching, collaborative filtering, sentiment analysis, online ad selection, and so forth. Internet search engines are some of the most widely known technologies using machine-learned algorithms. Internet search engines perform document searching and retrieval, in which documents are identified and ranked in response to queries supplied by users.

Learning-to-rank is a process that uses training data to create or optimize ranking algorithms. Training data consists of queries, corresponding search results, and reliable relevance rankings of the search results. The relevance rankings are often provided by human judges. In addition, click-through data can be used to provide reliable relevance rankings or to validate or enhance the rankings provided by the human judges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

The disclosure describes techniques for obtaining or optimizing training data for use in learning-to-rank procedures. The techniques use an existing set of training data, consisting of multiple triplets. Each triplet comprises a search specification or query, a document or other search result, and a relevance ranking that indicates the relative relevance of the document or other search result. The relevance rankings may be provided by human judges or by other means.

The training data is modeled by a probability function that is based in part on click-through data corresponding to the search results of the training data, and on model parameters that are initially unknown. Within the probability function, any particular search result is assumed to depend on the relevance of one or more other search results. In one implementation, it is assumed that the relevance of any individual search result depends on the relevance of an adjacent search result. In another implementation, it is assumed that the relevance of any individual search result depends on the relevance of all other search results.

Using the existing training data and available click-through data corresponding to the training data, the probability function is analyzed to determine the appropriate model parameters for future use in conjunction with the probability function. The model parameters fit the probability function to the training data in light of the click-through data. The probability function is then used with the model parameters and the click-through data to calculate a new set of rankings, which are referred to herein as predicted rankings.

The predicted rankings can be compared to the existing rankings to determine inconsistencies, and information regarding such inconsistencies may be used to improve judging methods or to otherwise enhance the training data. In some embodiments, inconsistencies may be flagged for further consideration. In other embodiments, existing rankings may be automatically corrected in light of the predicted rankings.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIGS. 1 and 2 are block diagrams illustrating concepts associated with producing enhanced training data for learning-to-rank algorithms.

FIG. 3 is a flowchart illustrating a procedure for producing enhanced training data for learning-to-rank algorithms.

FIG. 4 is a block diagram illustrating how enhanced training data can be used to in conjunction with a learning-to-rank algorithm.

FIG. 5 is a block diagram illustrating relevant components of a computer that may be used to implement the techniques described herein.

### DETAILED DESCRIPTION

### General Concepts

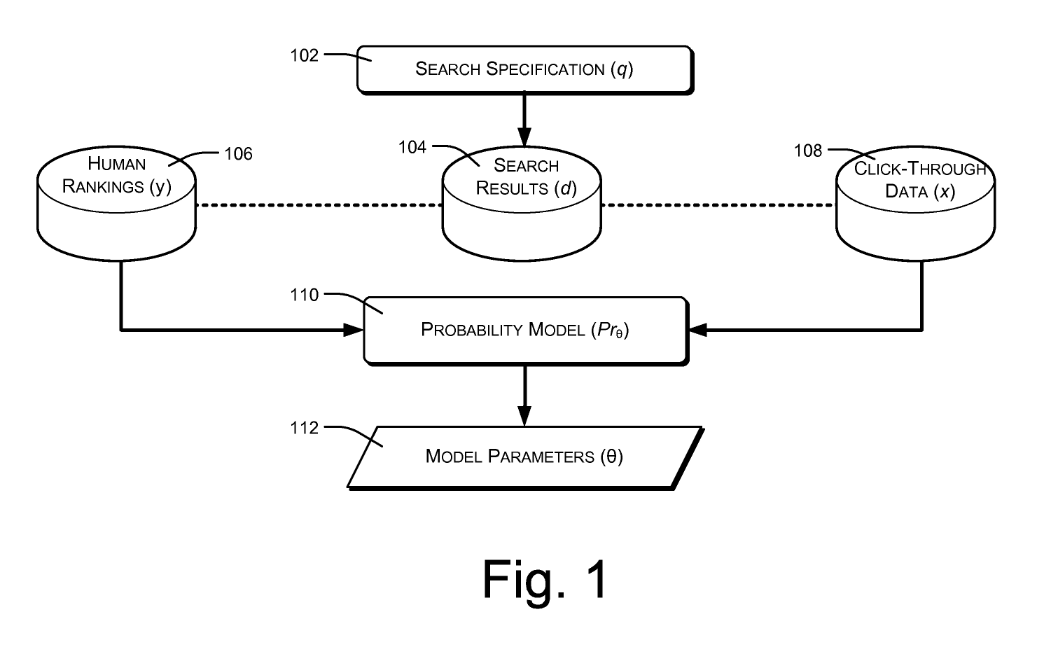

FIG. 1 illustrates examples techniques that can be used in a method of producing training data for a learning-to-rank algorithm. Search specifications 102 may be provided by a user, by a developer or by some other means. Search specifications 102 may be queries, each of which may comprise one or more keywords to be used in a document search. In some embodiments, search specifications 102 may comprise popular search queries, gathered from actual searches conducted by users through online services.

A set of search results 104 are generated from each search specification 102. Search results 104 may be generated manually, or using any of various search engines or document retrieval algorithms. In some embodiments, search results 104 are limited to the top or highest-ranking results, using the existing ranking methods of whatever document retrieval algorithm is used.

Note that although this description is given in the context of a document retrieval or search engine, the techniques described herein can be applied to other types of retrieval activities, such as document searching, collaborative filtering, sentiment analysis, online ad selection, and so forth. The term “search result” is used broadly, to indicate the output of these various different types of activities.

Search results 104 are ranked by one or more human judges to produce a set of human rankings 106 corresponding to search results 104. Specifically, each search result is given a relevance ranking indicating the relative relevance of that search result.

Click-through data 108 is also provided and associated with the search results. Click-through data 108 comprises information about actual human responses to search results 104 when using search specifications 102. For example, click-through data 108 may indicate the relative number of times a user actually selected a particular search result after submitting a particular search specification 102. This information can be gathered from actual search engines, by monitoring the responses of users to individual search queries.

A particular search specification 102 is thus associated with each set of search results 104, human rankings 106, and click-through data 108. This information can be organized as the following individual data items or data sets, corresponding to each search specification or query q:

a set of individual search results or documents d=(d₁, d₂, . . . , dₙ);

a set of corresponding human rankings y=(y₁, y₂, . . . , yₙ); and

a set of corresponding click-through data x=(x₁, x₂, . . . , xₙ).

A particular set of training data D may include data items for a plurality of search specifications or queries (q₁, q₂, . . . , q_{M}) as follows: D={(d^{m}, x^{m}, y^{m})}ₘ₌₁^{M}, where M is the number of search specifications included in the training data D. The click-through data 108 may also be considered as part of the training data D in some situations.

A probability model 110 (also referred to herein as probability model Pr_{θ}) is formulated to represent training data D. Probability model 110 is a function of a set of model parameters 112 (also referred to herein as model parameters θ), which are initially unknown. They are estimated in an analysis based on the training data D, as will be described in more detail below.

The probability model 110 assumes that, given the click-through data, the ranking of any particular search result is conditionally dependent on the relevance of one or more other search results. Two examples of this conditional dependence will be given below. In the first example, referred to as sequential dependency, the ranking of any individual search result is locally dependent: the ranking is conditionally dependent on the relevance of an adjacently ranked search result. This models the situation where a user compares a document with adjacent documents before selecting it. In the second example, referred to as full dependency, the ranking of any individual search result is universally dependent: the ranking is conditionally dependent on the relevance of all other search results. This models the situation where a compares a document with all other documents before selecting it. For example, a user will not usually select a document if it is a duplicate of any other document.

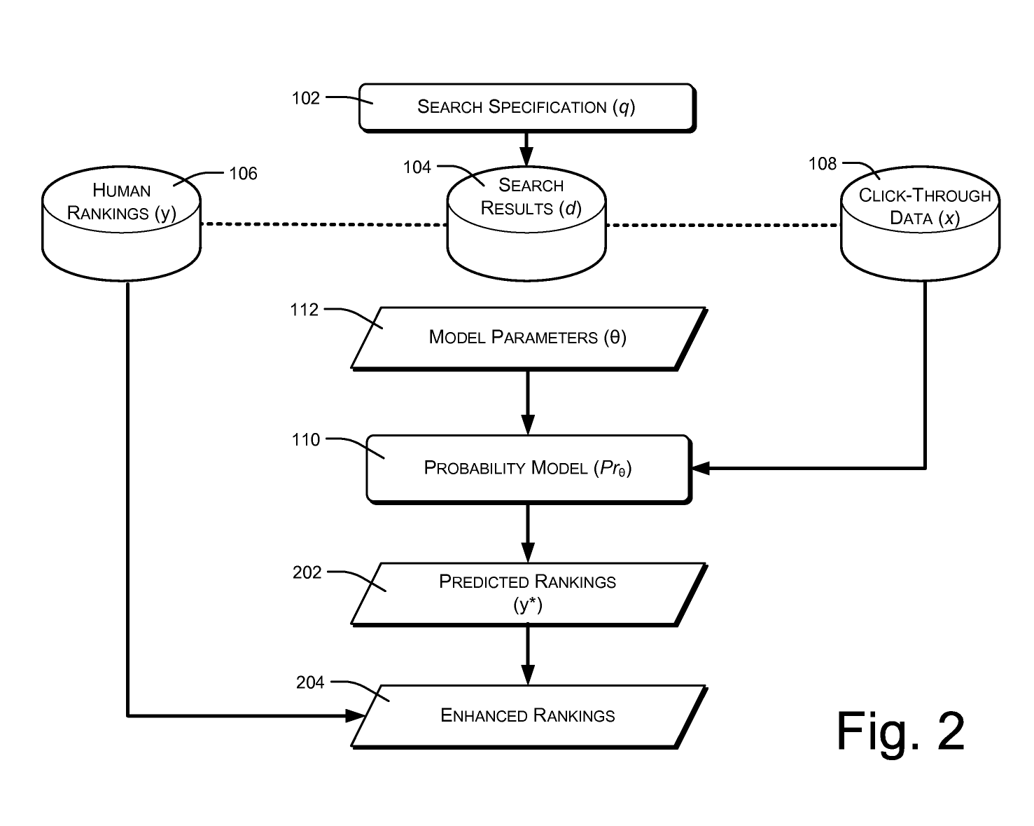

FIG. 2 continues the illustration of FIG. 1, showing additional techniques that may be used to produce training data. FIG. 2 assumes that the model parameters 112 have been estimated and are now known. The model parameters 112 are used with click-through data 108 in probability model 110 to calculate a set of predicted rankings 202 (also referred to herein as predicted rankings y*). The predicted rankings 202 may turn out to be the same as the human rankings 106, or they may be different. Any differences can be used to correct mistakes in the human rankings, resulting in a set of enhanced rankings 204.

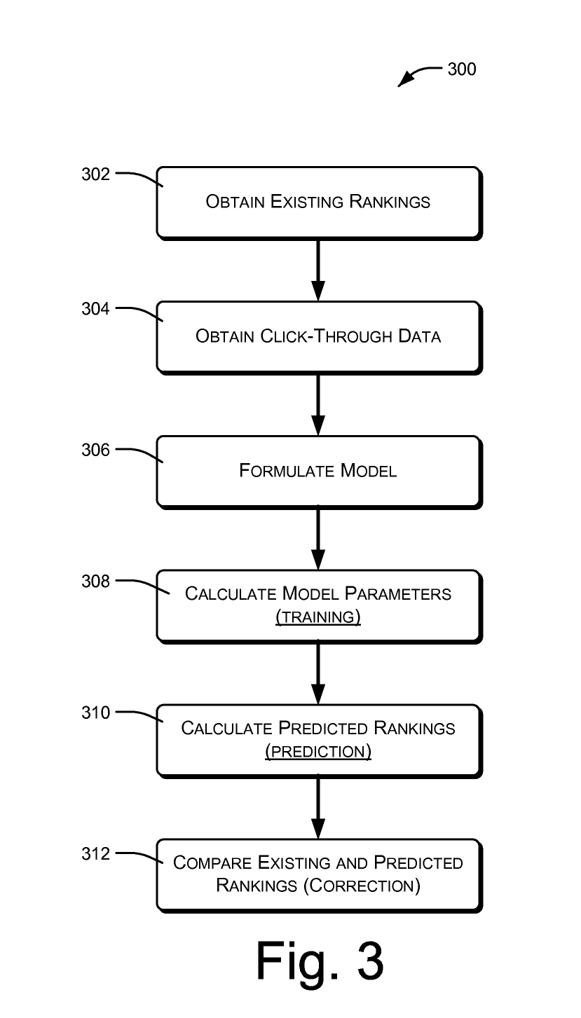

FIG. 3 shows an example of a procedure 300 for producing or enhancing training data for use in learning-to-rank algorithms, utilizing techniques and concepts illustrated in FIGS. 1 and 2. Actions 302, 304, and 306 are preparatory actions. Action 302 comprises obtaining rankings 106 of search results 104 corresponding to multiple queries 102. These rankings, referred to herein as existing rankings or human rankings, can be provided by a single judge, or by aggregating judgments from multiple judges.

Action 304 comprises obtaining click-through data 108 corresponding to the search results 104. Examples of click-through data 108 include click-through rates and dwell times. Further examples of click-through data will be described below.

Action 306 comprises formulating a model 110 of training data based on click-through data. This comprises modeling a set of search results as having rankings according to query relevance. It also comprises modeling the ranking of any particular search result as depending on the relevance of search results other than the particular search result. In an embodiment that assumes sequential dependency, the modeling assumes that the relevance of any individual search result depends on the relevance of an adjacent search result that is adjacent to the individual search result in an ordering of the search results based on their rankings. In an embodiment that assumes full dependency, the modeling assumes that the relevance of any individual search result depends on the relevance of all other search results. Specific models corresponding to these embodiments will be described in more detail below.

An action 308, which can be described as a training procedure or stage, comprises calculating model parameters 112 based on the existing rankings 106 and the click-through data 108. In this stage, it is assumed that human generated rankings 106 are of high quality.

An action 310, which can be described as a prediction stage, comprises calculating predicted rankings 202 based on probability model 110, click-through data 108, and the previously calculated model parameters 112. These calculations will be described in more detail below. The human generated rankings 106 are not involved in this stage. Rather, a predicted set of rankings 202 is generated based on the model parameters and the click-through data.

An action 312, which can be described as a correction stage, comprises comparing the existing rankings 106 and the predicted rankings 202, and correcting the existing rankings 106 based on the predicted rankings 202. In some embodiments, this comparison may be done by the original human judges who produced the existing rankings 106. Any discrepancies between the predicted rankings and the existing rankings may be automatically flagged for further examination by the human judges. The human judges may use the information to not only improve the current ranking data, but also to improve future judgments.

Note that sparseness of available click-through data may limit the above analysis to only the top-most results of a search. Nevertheless, providing this type of feedback to human judges may improve the quality of their judgments over time, thereby reducing the need for judging by multiple judges.

The sections below will describe more details regarding how to perform calculations of actions 306, 308, and 310.

### Sequential Dependency Model

The probability model 110 for the sequential dependency model can be defined as follows:

$${Pr}_{θ} ( y \vert x ) = \frac{1}{z ( x )} exp ( {\sum }_{i , k} {λ}_{k}^{i} {f}_{k} ( {y}_{i - 1} , {y}_{i} , x ) + {\sum }_{i , k} {μ}_{k}^{i} {g}_{k} ( {y}_{i} , x ) ) ;$$

where:
Pr_{θ}(y|x) indicates the probabililty of existing rankings y given x;
i is a position index in an ordered sequence of existing rankings y;
Z(x) is a normalization factor:

Z(x)=Σ_{y}exp(Σ_{i,k}λₖⁱfₖ(yᵢ₋₁,yᵢ,x)+Σ_{i,k}μₖⁱgₖ(yᵢ,x));
θ=(λ₁, λ₂ . . . ; μ₁, μ₂ . . . ) are the model parameters, which will be estimated;
fₖ represents multi-result or vertex feature functions, each of which indicates relevance of a particular search result dᵢ based on (a) the click-through data x, (b) the existing ranking yᵢ of the particular search result dᵢ, and (c) the existing ranking yᵢ₋₁ of an adjacent search result dᵢ₋₁; and
gₖ represents single-result or edge feature functions, each of which indicates relevance of a particular search result dᵢ based on (a) the click-through data x and (b) the existing ranking yᵢ of the particular search result dᵢ.

This sequential dependency model is position dependent. That is, although the same feature functions are defined for all the positions, each position has its own instances of feature functions with specific parameters λ and μ. This model can inherently capture position bias in click-through data.

Model parameters θ can be calculated by identifying the parameters (λ₁, λ₂ . . . ; μ₁, μ₂ . . . ) that maximize the log-likelihood objective function of {(x^{m}, y^{m})}ₘ₌₁^{M} with respect to the probability model Pr_{θ} in accordance with the following:

θ=arg max_{θ}L(θ)=arg max_{θ}Σₘ₌₁^{M} log(Pr_{θ}(y^{m}|x^{m}))

Because the objective function L(θ) is convex, the global maximum is guaranteed to exist. Differentiating the objective function with respect to parameter λₖⁱ gives

$$\frac{ϑℒ ( θ )}{{ϑλ}_{k}^{i}} = {\sum }_{m = 1}^{M} ( {f}_{k} ( {y}_{i - 1}^{m} , {y}_{i}^{m} , {x}^{m} ) - {\sum }_{{y}_{i - 1}^{m} , {y}_{i}^{m}} Pr ( {y}_{i - 1}^{m} , {y}_{i}^{m} \vert {x}^{m} ) {f}_{k} ( {y}_{i - 1}^{m} , {y}_{i}^{m} , {x}^{m} ) ) ;$$

and differentiating the objective function with respect to parameter μₖⁱ gives

$$\frac{ϑℒ ( θ )}{{ϑμ}_{k}^{i}} = {\sum }_{m = 1}^{M} ( {g}_{k} ( {y}_{i}^{m} , {x}^{m} ) - {\sum }_{{y}_{i}^{m}} Pr ( {y}_{i}^{m} \vert {x}^{m } ) {g}_{k} ( {y}_{i}^{m} , {x}^{m} ) ) ;$$

where Pr(yᵢ₋₁^{m}, yᵢ^{m}|x^{m}) can be calculated efficiently with a dynamic programming method such as a quasi-Newton optimization method. Specifically, the L-BFGS (limited-memory Broyden-Fletcher-Goldfarb-Shanno) method can be used.

Given click-through parameters x and model parameters θ, the predicted rankings y* can be calculated as follows:

y*=arg max_{y}Pr_{θ}(y|x)

### Full Dependency Model

The probability model 110 for the full dependency model can be defined as follows:

$${Pr}_{θ} ( y \vert x ) = \frac{1}{z ( x )} exp ( {\sum }_{i , j , k} {λ}_{k}^{i , j} {f}_{k} ( {y}_{i} , {y}_{j} , x ) + {\sum }_{i , k} {μ}_{k}^{i} {g}_{k} ( {y}_{i} , x ) ) ;$$

where:
Pr_{θ}(y|x) indicates the probabililty of existing rankings y given x;
i is a position index in an ordered sequence of existing rankings y;
Z(x) is a normalization factor:

Z(x)=Σ_{y}exp(Σ_{i,j,k}λₖ^{i,j}fₖ(yᵢ,yⱼ,x)+Σ_{i,k}μₖⁱgₖ(yᵢ,x));
θ=(λ₁, λ₂ . . . ; μ₁, μ₂ . . . ) are the model parameters, which will be estimated;
fₖ represents multi-result or vertex feature functions, each of which indicates relevance of a particular search result dᵢ based on (a) the click-through data x, (b) the existing ranking yᵢ of the particular search result dᵢ, and (c) the existing ranking yᵢ of another search result dᵢ; and
gₖ represents single-result or edge feature functions, each of which indicates relevance of a particular search result dᵢ based on (a) the click-through data x and (b) the existing ranking yᵢ of the particular search result dᵢ.

This full dependency model is position independent. That is, although the same feature functions are defined for all the positions, each position has its own instances of feature functions with specific parameters λ and μ, and can inherently capture position bias in click-through data.

Model parameters θ can be calculated by identifying the parameters (λ₁, λ₂ . . . ; μ₁, μ₂ . . . ) that maximize the log-likelihood objective function of {(x^{m}, y^{m})}ₘ₌₁^{M} with respect to the probability model Pr_{θ} in accordance with the following:

θ=arg max_{θ}L(θ)=arg max_{θ}Σₘ₌₁^{M} log(Pr_{θ}(y^{m}|x^{m}))

Differentiating the objective function with respect to parameter λₖⁱ gives

$$\frac{ϑℒ ( θ )}{{ϑλ}_{k}^{i , j}} = {\sum }_{m = 1}^{M} ( {f}_{k} ( {y}_{i}^{m} , {y}_{j}^{m} , {x}^{m} ) - {\sum }_{{y}_{i}^{m} , {y}_{j}^{m}} Pr ( {y}_{i}^{m} , {y}_{j}^{m} \vert {x}^{m} ) {f}_{k} ( {y}_{i}^{m} , {y}_{j}^{m} , {x}^{m} ) ) ;$$

and differentiating the objective function with respect to parameter μₖⁱ gives

$$\frac{ϑℒ ( θ )}{{ϑμ}_{k}^{i}} = {\sum }_{m = 1}^{M} ( {g}_{k} ( {y}_{i}^{m} , {x}^{m} ) - {\sum }_{{y}_{i}^{m}} Pr ( {y}_{i}^{m} \vert {x}^{m} ) {g}_{k} ( {y}_{i}^{m} , {x}^{m} ) ) .$$

In this case, it may not be possible to compute Z(x) efficiently with a dynamic programming method. However, the Gibbs Sampling method can be used to sample N solutions with the highest probabilities to approximate the complete solution space, and to then calculate Pr(yᵢ^{m}, yⱼ^{m}|x^{m}) and Z(x) based on the sampled data. With such an approximation, the L-BFGS method can still be employed to estimate the model parameters θ.

To calculate predicted rankings y in this situation, a quadratic programming relaxation method can be used to solve the maximum a posteriori (MAP) problem. This method is described in P. Ravikumar and J. Lafferty; “Quadratic Programming Relaxations for Metric Labeling and Markov Random Field Map Estimation”; ICML '06: Proceedings of the 23^{rd} International Conference on Machine Learning, pages 737-744; ACM, 2006.

More precisely, indicator functions are defined as follows:

$${I}_{s} ( {y}_{i} ) = \{ \begin{matrix}1 & if {y}_{i} = {l}_{s} \\ 0 & otherwise\end{matrix}$$

In light of this, the most likely rankings are given by

y*=arg max_{y}Σ_{i,j,k,s,t}λₖ^{i,j}fₖ(lₛ,lₜ,x)Iₛ(yᵢ)Iₜ(yⱼ)+Σ_{i,k,s}μₖⁱgₖ(Iₛ,x)Iₛ(yᵢ).

Letting a variable v(i; s) be the relaxation of indication variable Iₛ(yᵢ), the quadratic program (QP) issue is as follows:

max Σ_{i,j,k,s,t}λₖ^{i,j}fₖ(lₛ,lₜ,x)v(i; s)v(j; t)+Σ_{i,k,s}μₖⁱgₖ(lₛ,x)v(i; s)

s.t. Σₛv(i; s)=1

0≦v(i; s)≦1

This equation is solvable in polynomial time with convex programming. In addition, Ravikumar describes an iterative update procedure that can solve this equation. Specifically, when considering yᵢ, it is assumed that values for the others are fixed: v(j; .) j≠i. Then, the optimal ranking at position i is given by

s*(i)=arg maxₛΣ_{j,k,t}λₖ^{i,j}fₖ(lₛ,lₜ,x)v(j; t)Iₜ(yⱼ)+Σₖμₖⁱgₖ(lₛ,x)

v(i; s)=I_{s*}(yᵢ)

Individual rankings of y can then be found by iteratively updating this function at each position i.

### Features

The techniques above assume two types of features: vertex features fₖ and edge features gₖ. Vertex features represent information relating to a single search result, while edge features represent information relating to relationships between search results. Various of these features can be directly derived from click-through log data of production search engines.

Examples of vertex features include:
ClickthroughRate (r₁, r₂): whether the clickthrough rate with respect to a search results is in the range of [r₁, r₂].
DwellTime (t₁, t₂): whether the time users spend on a particular search result is in the range of [t₁, t₂].
LastClick (p₁, p₂): whether the probability of a search result being the last click of a session is in the range of [p₁, p₂].

Examples of edge features include:
ClickthroughRateDiff (r₁, r₂): whether the difference between clickthrough rates of two search results is in the range of [r₁, r₂].
DwellTimeDiff (t₁, t₂): whether the difference between times users spend on two search results is in the range of [t₁, t₂].
LastClickDiff (p₁, p₂): whether the difference between the probabilities of two search results being the last click of respective sessions is in the range of [p₁, p₂].
Duplicate: whether two search results are duplicates.

### Learning-To-Rank System

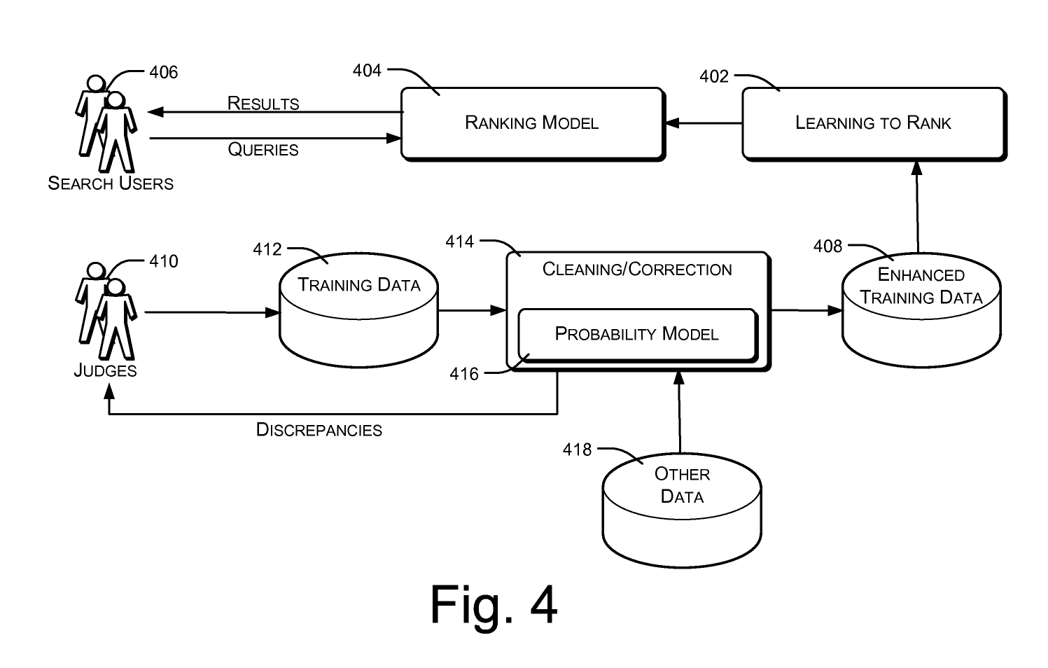

FIG. 4 shows an example of how the techniques described above can be used in conjunction with a learning-to-rank algorithm 402 to formulate or refine a ranking model 404. Ranking model 404 is used to rank search results for search users 406.

Learning-to-rank algorithm 402 depends on training data. Such training data, as described above, comprises search specifications, search results, and verified or high-quality rankings of the search results. In this example, learning-to-rank algorithm 402 utilizes enhanced training data 408, which is the result of the techniques described above.

More specifically, a set of human judges 410 provide initial training data 412 based on their best judgments. This initial training data 412, also referred to as existing training data herein, is then subjected to a cleaning/correction process 414. Cleaning/correction process 414 uses a probability model 416 as described above, along with other data 418 such as click-through data, to detect and flag any rankings within training data 412 that may be erroneous. This information is provided back to human judges 410. Based on this information, the human judges correct or refine their rankings and re-submit them. This results in enhanced training data 408.

In the described embodiment, enhanced training data 408 is ultimately the result of human judgment. However, the human judgment has now been informed and potentially improved by the feedback from cleaning/correction process 414.

### Computing System

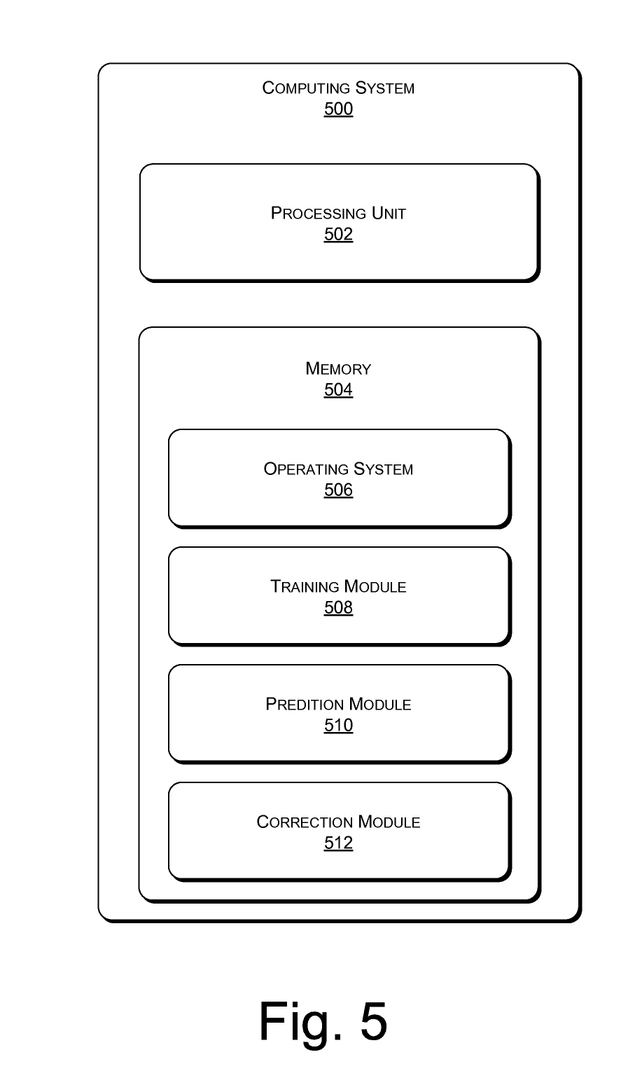

The techniques described above can be implemented by a general-purpose or special-purpose computing device. FIG. 5 shows a simplified example of a computing system 500 that may be used to implement the techniques. Generally, computing system 500 comprises a processing unit 502 that may comprise one or more individual processors. Computing system 500 also has various types of memory 504, which may include both volatile and non-volatile memory. Programs, comprising instruction sequences and/or other specifications, are stored in memory 504 and retrieved and executed by processing unit 502.

In the illustrated example, the programs include an operating system 506 that provides basic functionality and interfaces with a user and various system components that are not shown. The memory may also store a training module 508 that performs the functionality described above with reference to block 308 of FIG. 3. The memory may also store a prediction module 510 that performs the functionality described above with reference to block 510 of FIG. 3. The memory may further store a correction module 512 that performs or facilitates the functionality described above with reference to block 312 of FIG. 3.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A method of producing training data for a learning-to-rank algorithm, the method comprising:
obtaining {x^{m}}ₘ₌₁^{M} corresponding to {d^{m}}ₘ₌₁^{M} where x is a set of click-through data corresponding to a set of search results d;
modeling the training data in accordance with the following conditional probability function that indicates the probability of y given x:
$${Pr}_{θ} ( y \vert x ) = \frac{1}{z ( x )} exp ( {\sum }_{i , k} {λ}_{k}^{i} {f}_{k} ( {y}_{i - 1} , {y}_{j} , x ) + {\sum }_{i , k} {μ}_{k}^{i} {g}_{k} ( {y}_{i} , x ) ) ;$$
where
y is a set of existing rankings of the search results d;
i is a position index in an ordered sequence of the existing rankings y;
Z(x) is a normalization factor;
fₖ represents multi-result functions, each of which indicates relevance of a particular search result dᵢ based on (a) the click-through data x, (b) the existing ranking yᵢ of the particular search result dᵢ, and (c) the existing ranking of an adjacent search result dᵢ₋₁;
gₖ represents single-result functions, each of which indicates relevance of a particular search result dᵢ based on (a) the click-through data x and (b) the existing ranking yᵢ of the particular search result dᵢ;
identifying parameters θ=(λ₁, λ₂ . . . ; μ₁, μ₂ . . . ) that maximize the log-likelihood objective function of {(x^{m}, y^{m})}ₘ₌₁^{M} with respect to the conditional probability function; and
calculating {y*^{m}}ₘ₌₁^{M} using the identified parameters, where y* is a set of predicted rankings corresponding to search results d.

2. A method as recited in claim 1, wherein {y*^{m}}ₘ₌₁^{M} is calculated in accordance with the following equation:
y*=arg max_{y}Pr_{θ}(y|x).

3. A method as recited in claim 1, further comprising correcting the existing rankings based on the predicted rankings.

4. A method as recited in claim 1, further comprising obtaining the existing rankings from human judges.

5. A method of producing training data for a learning-to-rank algorithm, the method comprising:
obtaining {x^{m}}ₘ₌₁^{M} corresponding to {d^{m}}ₘ₌₁^{M} where x is a set of click-through data corresponding to a set of search results d;
modeling the training data in accordance with the following conditional probability function that indicates the probability of y given x:
$${Pr}_{θ} ( y \vert x ) = \frac{1}{z ( x )} exp ( {\sum }_{i , j , k} {λ}_{k}^{i , j} {f}_{k} ( {y}_{i} , {y}_{j} , x ) + {\sum }_{i , k} {μ}_{k}^{i} {g}_{k} ( {y}_{i} , x ) ) ;$$
where
y is a set of existing rankings of the search results d;
i is a position index in an ordered sequence of the existing rankings y;
Z(x) is a normalization factor;
fₖ represents multi-result functions, each of which indicates relevance of a particular search result dᵢ based on (a) the click-through data x, (b) the existing ranking y of the particular search result dᵢ, and (c) the existing ranking yᵢ of an another search result dᵢ;
gₖ represents single-result functions, each of which indicates relevance of a particular search result dᵢ based on (a) the click-through data x and (b) the existing ranking yᵢ of the particular search result dᵢ;
identifying parameters θ=(λ₁, λ₂ . . . ; μ₁, μ₂ . . . ) that maximize the log-likelihood objective function of {(x^{m}, y^{m})}ₘ₌₁^{M} with respect to the conditional probability function; and
calculating {y*^{m}}ₘ₌₁^{M} using the identified parameters, where y* is a set of predicted rankings corresponding to search results d.

6. A method as recited in claim 5, further wherein {y*^{m}}ₘ₌₁^{M} is calculated using quadratic programming relaxation.

7. A method as recited in claim 5, further comprising correcting the existing rankings based on the predicted rankings.

8. A method as recited in claim 5, further comprising obtaining the existing rankings from human judges.

9. A method of producing training data for a learning-to-rank algorithm, the method comprising:
modeling search results as having rankings according to relevance to a query;
further modeling the ranking of any particular search result as depending on the relevance of search results other than the particular search result;
calculating model parameters for the modeling based on (a) existing rankings of the search results and (b) click-through data corresponding to the search results; and
calculating predicted rankings of the search results based on the modeling using the model parameters and the click-through data corresponding to the search results.

10. A method as recited in claim 9, further comprising comparing the predicted rankings with the existing rankings to produce enhanced rankings.

11. A method as recited in claim 9, further comprising obtaining the existing rankings from human judges.

12. A method as recited in claim 9, further comprising assuming within the modeling that the relevance of any individual search result depends on the relevance of an adjacent search result that is adjacent to the individual search result in an ordering of the search results based on their rankings.

13. A method as recited in claim 12, wherein the modeling is performed in accordance with the following equation:
$${Pr}_{θ} ( y \vert x ) = \frac{1}{Z ( x )} exp ( {\sum }_{i , k} {λ}_{k}^{i} {f}_{k} ( {y}_{i - 1} , {y}_{i} , x ) + {\sum }_{i , k} {μ}_{k}^{i} {g}_{k} ( {y}_{i} , x ) )$$
where:
x represents the click-through data corresponding to the search results;
y represents a set of rankings corresponding to the search results;
θ=(λ₁, λ₂ . . . ; μ₁, μ₂ . . . ) are the model parameters;
Pr_{θ}(y|x) is the conditional probability of y given x;
Z(x) is a normalization factor;
fₖ represents edge feature functions;
gₖ represents vertex feature functions; and
i is a position index in an ordering of the search results based on their rankings.

14. A method as recited in claim 13, wherein:
Z(x)=Σ_{y}exp(Σ_{i,k}λₖⁱfₖ(yᵢ₋₁,yᵢ,x)+Σ_{i,k}μₖⁱgₖ(yᵢ,x)).

15. A method as recited in claim 13, wherein calculating the model parameters comprises identifying the model parameters θ=(λ₁, λ₂ . . . ; μ₁, μ₂ . . . ) that maximize the log-likelihood objective function of {(x^{m}, y^{m})}ₘ₌₁^{M} with respect to the modeling.

16. A method as recited in claim 13, wherein calculating the model parameters comprises identifying the model parameters θ=(λ₁, λ₂ . . . ; μ₁, μ₂ . . . ) in accordance with the following:
θ=arg max_{θ}L(θ)=arg max_{θ}Σₘ₌₁^{M} log(Pr_{θ}(y^{m}|x^{m})).

17. A method as recited in claim 9, further comprising assuming within the modeling that the relevance of any individual search result depends on the relevance of all other search results.

18. A method as recited in claim 17, wherein the modeling is performed in accordance with the following equation:
$${Pr}_{θ} ( y \vert x ) = \frac{1}{Z ( x )} exp ( {\sum }_{i , j , k} {λ}_{k}^{i , j} {f}_{k} ( {y}_{i} , {y}_{j} , x ) + {\sum }_{i , k} {μ}_{k}^{i} {g}_{k} ( {y}_{i} , x ) )$$
where:
x represents the click-through data corresponding to the search results;
y represents a set of rankings corresponding to the search results;
θ=(λ₁, λ₂ . . . ; μ₁, μ₂ . . . ) are the model parameters;
Pr_{θ}(y|x) is the conditional probability of y given x;
Z(x) is a normalization factor;
fₖ represents edge feature functions;
gₖ represents vertex feature functions; and
i is a position index in an ordering of the search results based on their rankings.

19. A method as recited in claim 18, wherein:
Z(x)=Σ_{y}exp(Σ_{i,j,k}λₖ^{i,j}fₖ(yᵢ,yⱼ,x)+Σ_{i,k}μₖⁱgₖ(yᵢ,x)).

20. A method as recited in claim 18, wherein calculating the model parameters comprises identifying the model parameters θ=(λ₁, λ₂ . . . ; μ₁, μ₂ . . . ) that maximize the log-likelihood objective function of {(x^{m}, y^{m})}ₘ₌₁^{M} with respect to the modeling.
